(19) United States
(12) Patent Application Publication
(10) Pub. No.: US 2004/0001962 A1
(43) Pub. Date: Jan. 1, 2004

(54) Monovinylaromatic polymer with improved stress crack resistance

(76) Inventors: B. Raghava Reddy, Duncan, OK (US); Kenneth P. Blackmon, Houston, TX (US)

Correspondence Address: David J. Alexander, Fina Technology, Inc., P.O. Box 674412, Houston, TX, 77267-4412, US

(21) Appl. No.: 10/608,967

(22) Filed: Jun. 27, 2003

Related U.S. Application Data
(63) Continuation-in-part of application No. 09/379,813, filed on Aug. 23, 1999, now Pat. No. 6,613,837.
Application No. 09/379,813 is a continuation of application No. 08/828,206, filed on Mar. 21, 1997, now abandoned.
Application No. 08/828,206 is a continuation of application No. 08/547,824, filed on Oct. 25, 1995, now abandoned.

(51) Int. Cl. C08L 51/00

(52) U.S. Cl. 428/500; 525/70; 524/849

(57) ABSTRACT

The present invention discloses a composition of matter consisting of a high impact polystyrene exhibiting improved environmental stress crack resistance. The composition can comprise a rubber-modified polymer formed by the polymerization of a monovinylaromatic monomer in the presence of a rubber selected from the group consisting of natural rubbers, polybutadienes, polyisoprenes, and copolymers of butadienes or isoprene with styrene. At least one ESCR enhancing additive is added chosen from the group consisting of polyisobutylene, polymerized alpha-olefins of at least 10 carbons, atactic polypropylene, or polyolefin copolymers.

### CROSS REFERENCED TO RELATED APPLICATION

This application is a continuation-in-part of application Ser. No. 09/379,813 filed Aug. 23, 1999, which is a continuation of application Ser. No. 08/828,206 filed Mar. 21, 1997, now abandoned, which is a continuation of application, Ser. No. 08/547,824, filed Oct. 25, 1995, now abandoned.

### FIELD OF THE INVENTION

The present invention relates to thermoplastic compositions utilizing polymers of monovinylaromatic compounds which have been modified with rubber to increase their impact strength and which are particularly useful for manufacturing articles requiring increased environmental stress crack resistance (ESCR). More particularly, the present invention discloses a high impact polystyrene (HIPS) material that is particularly advantageous for use in food product containers that are normally subject to environmental stress cracking.

### BACKGROUND OF THE INVENTION

It is well known that rubber-reinforced polymers of monovinylaromatic compounds, such as styrene, alphamethyl styrene and ring substituted styrenes are desirable for a variety of uses. More particularly, rubber reinforced polymers of styrene having included therein discrete particles of a crosslinked rubber, for example, polybutadiene, the discrete particles of rubber being dispersed throughout the styrene polymer matrix, can be used in a variety of applications including refrigerator linings, packaging applications, furniture, household appliances and toys. The conventional term for such rubber reinforced polymers is “High Impact Polystyrene” or “HIPS.” The physical characteristics and mechanical properties of HIPS are dependent upon many factors, including the particle size of the crosslinked rubber particles. One of the most desirable characteristics of HIPS material is the ability of such material to resist environmental stress cracking. This ability must be coupled with a high impact strength in order to be useful in articles such as food containers. In addition, other such properties which must be maintained for such articles include flexural strength and tensile strength.

The property of stress crack resistance, or environmental stress crack resistance (ESCR), is particularly important in thermoplastic polymers utilized in food containers. The food content of such polymer containers might not normally degrade the type of polymeric material of which the container is made, but when a thermoplastic polymer is thermoformed from extruded sheet material, residual stresses are locked into the molded article. These stresses open the polymer up to attack by substances which it would normally be totally resistant to. Such articles made from styrene polymers modified with rubber to increase impact strength are prone to stress cracking when they come into contact with common agents found in organic food products such as fats and oils. Likewise, such products are also subject to stress cracking when coming into contact with organic blowing agents such as halohydrocarbons, containing fluorine and chlorine. These polymers generally are found in household items such as refrigerator liners, which may crack when the cavities in the refrigerators are filled with a polyurethane foam as a result of the blowing agent utilized in the foam.

In the past, environmental stress cracking has been prevented by complex procedures usually involving multiple layer polymer construction wherein an intermediate protective layer of polymer is placed between the polystyrene layer and the blowing agent or the fatty food materials. One such layer of material utilized to insulate the styrene from these agents is the terpolymer material known as ABS, or acrylonitrile-butadiene-styrene. Other attempts to improve the stress crack resistance of high impact monovinylaromatic polymers have been to increase the amount of rubber mixed in the polymer. Unfortunately the higher rubber content decreases the tensile and flexural strengths. Other solutions have involved the use of tightly controlling process conditions to maintain strict control over particle size of the rubber particles crosslinked within the polystyrene matrix. One such patent disclosing this technique is that granted to the assignee of the present invention, U.S. Pat. No. 4,777,210, issued Oct. 11, 1988, in which a continuous flow process for producing high impact polystyrene and for providing reliable and reproducible methods for varying particle sizes was disclosed. In that patented process, a pre-inversion reactor was utilized to convert a solution of styrene, polystyrene, rubber (such as polybutadiene) and a peroxide catalyst into a high impact polystyrene material exhibiting, high environmental stress crack resistance.

Another attempt to improve stress crack resistance was that disclosed in U.S. Pat. No. 4,144,204 to Mittnacht, et al., dated Mar. 13, 1979, in which a monovinylaromatic compound was modified with rubber to increase the ESCR and wherein the amount of rubber dissolved in the monomer prior to polymerization was chosen so that the content of the soft component (gel phase) in the impact resistance polymer was at least 28% by weight and preferably 38% by weight or more, based on the weight of the impact resistant polymer. The upper limit of the content of soft component was about 50 to 60% by weight and a preferable range of 30 to 40% by weight was found advantageous.

A third method used conventionally to increase ESCR in HIPS is that disclosed in British patent specification 1,362,399 in which a liquid hydrocarbon telomer having an unsaturated carbon chain is added to the HIPS material in amounts ranging from 0.2 up to 5 parts per hundred. Telomers are defined in Websters' Unabridged Dictionary as the products of chemical reaction involving the addition of fragments of one molecule (such as alcohol, acetal or chloroform) to the ends of a polymerizing olefin chain. In the British patent, the specific telomers used were butadiene telomers terminated by benzyl groups from benzyl chloride, having number average molecular weights in the range of 1000 to 6000. Experiments attempting to utilize low molecular weight polybutadienes to manufacture ESCR-HIPS have been unsuccessful because of cross-linking, indicating that this patented process utilizes butadienes which are compounded or blended with polystyrene rather than being added during the polymerization reaction.

Another attempt to improve the stress crack resistance of HIPS material can be found in British Patent No. GB 2,153,370A, wherein a HIPS material was manufactured utilizing a high molecular weight rubber material having a stated molecular mass of at least 300,000, a viscosity greater than or equal to 140 centipoise; the resulting HIPS containing between 7 and 10% by weight of rubber, and the polymerization being carried out in the presence of alphamethyl styrene dimer or a compound chosen from n-dodecylmercaptan, tertiarydodecylmercaptan, diphenyl 1,3 butadiene, or various other compounds or mixtures thereof. Also, this process was carried out in the presence of cyclohexane and ethylbenzene equal to at least 7% by weight of the total ingredients. In addition, additives including monotriglycerides of stearates from polyethylene waxes were also necessary.

On the other hand, additives are used for reasons besides ESCR improvement. U.S. Pat. No. 3,506,740 to Dempsey, et al. teaches the use of low molecular weight polyolefins as internal lubricants for impact polystyrene compositions. Listed examples include polypropylenes and polybutylenes with molecular weights in the range of 800 to 1600 (as measured by vapor pressure osmometry).

### SUMMARY OF THE INVENTION

The present invention discloses a composition of matter consisting of a high impact polystyrene exhibiting improved environmental stress crack resistance. The composition can comprise a rubber-modified polymer formed by the polymerization of a monovinylaromatic monomer in the presence of a rubber selected from the group consisting of natural rubbers, polybutadienes, polyisoprenes, and copolymers of butadienes or isoprene with styrene. At least one ESCR enhancing additive is added chosen from the group consisting of polyisobutylene, polymerized alpha-olefins of at least 10 carbons, atactic polypropylene, or polyolefin copolymers.

The monovinylaromatic monomer can be selected from the group consisting of styrene, alphamethyl styrene and ring-substituted styrenes. The rubber can be in the range of about 5 to 15 percent by weight. The composition can further comprise a chain transfer agent.

The ESCR enhancing additive can be added to the polymer composition in amounts of from about 0.1 wt % to about 6 wt % of the composition. More than one ESCR enhancing additive can be present in the amount of about 0.5 to about 3.0 percent by weight each. The composition can further comprise mineral oil in amounts of from about 0.1 wt % to about 6 wt % of the composition. The ESCR enhancing additive can alternatively comprise copolymers of ethylene and propylene that are amorphous ethylene-propylene copolymers.

The resulting composition can have an ESCR value greater than about 75.

An alternate embodiment comprises a molded thermoplastic article made from the polymeric composition of the invention. The article can comprise a refrigerator liner or a molded thermoplastic food product container.

Another embodiment of the invention is a process for producing a composition, comprising polymerizing a mixture of a monovinylaromatic monomer and rubber. The monovinylaromatic monomer can be selected from the group consisting of styrene, alphamethyl styrene and ring-substituted styrenes. The rubber can be selected from the group consisting of polybutadiene, polyisoprene, copolymers of butadiene or isoprene with styrene, and natural rubbers. Added to the mixture of monomer and rubber, prior to or during the polymerizing process, is at least one ESCR enhancing additive chosen from the group consisting of polyisobutylene, polymerized alpha-olefins of at least 10 carbons, atactic polypropylene, or a polyolefin copolymer. The resulting composition can have an ESCR value greater than about 75.

Mineral oil can be added to the mixture in amounts of from about 0.1 wt % to about 6 wt % of the composition. The ESCR enhancing additive can be added to the mixture in amounts of from about 0.1 wt % to about 6 wt % of the composition. The rubber can be present in the range of about 5 to 15 percent by weight. The process can further comprise adding a chain transfer agent to the mixture.

Yet another embodiment of the invention is a food service article made from a composition comprising: a rubber-modified polymer formed by the polymerization of a monovinylaromatic monomer in the presence of a rubber; and at least one ESCR enhancing additive chosen from the group consisting of polyisobutylene, polymerized alpha-olefins of at least 10 carbons, atactic polypropylene, or a polyolefin copolymer.

The composition can have an ESCR value of at least 75, and can comprises a refrigerator liner or a molded thermoplastic food product container.

### DESCRIPTION OF THE PREFERRED EMBODIMENTS

The present invention discloses a thermoplastic composition containing a polymer of a monovinylaromatic compound which has been modified with a rubber to increase its impact strength and environmental stress crack resistance, which compound is obtained by polymerizing the monovinylaromatic material in the presence of the rubber. In the composition, the portion of the soft component in the polymer, which has been modified to increase the impact strength, is less than 28% by weight based on the polymer, the soft component being defined as the toluene-insoluble constituent of the polymer which has been modified to increase its impact strength, minus any pigment which may be present. The particular rubber utilized in the present invention could be one of several types, for example the type sold by Firestone and designated as Diene 55 having a Mooney viscosity of approximately 55, a number molecular weight of about 150,000, weight average molecular weight of about 300,000, and a Z molecular weight of about 500,000 as measured by the gel permeation technique. Another type of advantageous rubber material includes the high-Cis rubbers.

The high impact polymers may be manufactured in accordance with any conventional process, provided the constituents mentioned hereinabove are utilized. Normal manufacturing processes include mass polymerization and solution polymerization such as that disclosed in U.S. Pat. No. 2,694,692 or mass suspension polymerization such as that disclosed in U.S. Pat. No. 2,862,906. Other processes of manufacture may also be used, provided the processes are capable of utilizing the constituents mentioned hereinabove.

Suitable monovinylaromatic compounds utilizing the present invention include styrene as well as styrenes alkylated in the nucleus or side-chain such as alphamethylstyrene and vinyltoluene. The monovinylaromatic compounds may be employed singly or as mixtures. In one preferred embodiment, styrene was the monovinylaromatic compound of preference. The high impact polystyrene manufactured according to the present invention is formed by polymerizing the monovinylaromatic compound in the presence of the rubber. The level of rubber utilized is preferably in the range of about 5-15% by weight of the solution. The polymerization is carried out in a conventional manner by mass polymerization, solution polymerization, or polymerization in aqueous dispersion, the rubber first being dissolved in the polymerizable monomer and this solution then being subjected to polymerization. Suitable polymerization initiators, e.g. peroxides or azo-type compounds, may be used to obtain desirable polymerization rates. When using solution polymerization, the starting solution may be mixed with up to about ten percent (10%) by weight based on the monovinylaromatic compound employed of an inert diluent. Preferred inert diluents include aromatic hydrocarbons or mixtures of aromatic hydrocarbons such as toluene, ethylbenzene, xylenes, or mixtures of these compounds. Suitable chain transfer agents, e.g. mercaptans or alphamethyl styrene dimer, may also be added to control polymer molecular weight and rubber particle size.

The present invention may also be utilized in a continuous flow process for producing polystyrene utilizing a pre-inversion reactor in which a solution of styrene and rubber are polymerized to a point below the inversion and then introduced into a second stirred tank reactor. The viscosity of the solutions in the pre-inversion and in the second stirred tank reactor are closely controlled to produce desirable HIPS. The particular process for manufacturing the preferred embodiment may be found in U.S. Pat. No. 4,777,210 to Sosa, et al., dated Oct. 11, 1988, the entire disclosure of which is hereby incorporated herein by reference.

The ESCR-enhancing additives may be added to the initial monomer/rubber feed stream or at any point in the polymerization process up to and including the final polymerization reactor. The synergistic additive combination which was found to provide unexpected increases in ESCR properties comprised polyisobutylene (PIB) and more specifically, PIB with viscosity in the range of 196-233 cst at 99° C., and mineral oil. These additives are utilized in varying proportions with a preferable ratio of approximately equal proportions in amounts of about 0.5 up to about 3.0% by weight, with a preferable final ratio of about 2.0% mineral oil and 2.0% pm (by weight) in the final product.

In a first embodiment of the invention, a mixture of conventional rubber having a molecular weight corresponding to a Mooney viscosity of approximately 55 and styrene monomer was polymerized into a high impact polystyrene material by the above-mentioned patented process. During the later stages of polymerization of this HIPS material, a combination of lubricant additives comprising 1.25% of mineral oil and 1.25% PIB by weight was added in one intermediate stage reactor. The PIB exhibited a viscosity of about 196-233 cst at 99° C., and the mineral oil exhibited a viscosity of about 78.7 cst at 38° C. The mineral oil selected was a commercially available product sold by Pennzoil Products Company (Penreco Div.) and identified as “Penreco Supreme Mineral Oil.” The particular PIB utilized was a commercially available product sold by Amoco Corporation and designated as H100, having a measured viscosity range of 196-233 cst at 99° C. and Mₙ of 965 as determined by gel permeation chromatography (“gpc”) . The finished product was then tested for environmental stress crack resistance and tensile strength, with the results set out below in Table I as Sample “F”, which compared HIPS materials with varying levels of mineral oil or PIB lubricants.

It can be seen from Table I that the conventional mineral-oil-modified high impact polystyrene and PIB-modified high impact polystyrene both exhibit a much lower ESCR than the material manufactured with the blend of equal proportions of mineral oil and PIB lubricants.

For example, Sample “A” represents a conventional HIPS material, or Control, of straight HIPS material with no lubricant. The ESCR value is 41.1 for this material. Sample “B” is a HIPS material manufactured with only 1.5% mineral oil as a lubricant. The resulting ESCR value for this sample was significantly higher at 52.2. By increasing the mineral oil content to 2.5% by weight as in Sample “C,” the ESCR value of the HIPS material was increased to 61.7.

Samples “D” and “E” utilized a PIB lubricant in place of the mineral oil of the earlier samples. The first contained PIB at a level of 1.5% by weight, obtaining an ESCR value of 85. The second PIB sample utilized a 2.5% level of PIB and improved the ESCR to 90.6.

Sample “F”, however, contained moderate but relatively equal amounts of PIB and mineral oil and exhibited by far the best ESCR value of all: 96.3. The last example, “G”, was a HIPS material using a blend of PIB and mineral oil additives in which the mineral oil was doubled and the PIB held constant from Example “F”. The resulting ESCR was much lower at 83. Thus it can be seen that relatively equal and moderate amounts of both mineral oil and PIB additives provide an unexpected increase in the ESCR value of HIPS material.

TABLE I
Characterization of HIPS Samples Produced for ESCR Study

| | | | | | | F | G |
|---|---|---|---|---|---|---|---|
| | | | | D | E | 1.25% MO + | 2.5% MO + |
| | A | B | C | 1.5% | 2.5% | 1.25% | 1.25% |
| Property | Control | 1.5% MO | 2.5% MO | H100 | H100 | H100 | H100 |
| Tg | 108.0 | 100.2 | 100.0 | 104.8 | 105.0 | 99.58 | 94.11 |
| % Rubber | 8.48 | 8.81 | 8.34 | 8.9 | 8.79 | 8.74 | 8.61 |
| Swell | 7.63 | 8.37 | 7.28 | 8.2 | 8.18 | 8.43 | 8.46 |
| Index | | | | | | | |
| Gels | 20.81 | 20.51 | 19.79 | 20.4 | 19.19 | 20.85 | 19.4 |
| Grafting | 145 | 133 | 137 | 129 | 118 | 139 | 125 |
| Toluene | | | | | | | |
| M-RPS, μ | 6.17 | 6.68 | 6.38 | 6.48 | 6.62 | 6.59 | 6.57 |
| Mw | 280750 | 271520 | 278700 | 284960 | 279500 | 274650 | 269600 |
| Mn | 115690 | 106000 | 112600 | 115390 | 120400 | 1093880 | 106600 |
| MWD | 2.43 | 2.56 | 2.48 | 2.47 | 2.32 | 2.51 | 2.53 |
| ESCR | 41.1 | 65.4 | 61.7 | 85 | 90.6 | 96.3 | 83 |
| Control | 3923 | 2651 | 2741 | 3271 | 3111 | 2595 | 2594 |
| Tens.Str. | | | | | | | |
| @ Max. psi | | | | | | | |
| ESCR | 1614 | 1733 | 1690 | 2780 | 2820 | 2499 | 2153 |
| Tens. Str | | | | | | | |
| @ Max. psi | | | | | | | |

NOTES:
1) Viscosities - Mineral Oil, 78.7 cst@38° C., H100-196-233 cst @ 99° C.
2) The concentrations of these additives in the final product will be higher than the amounts added due to the loss of a considerable portion of styrene (20-35%) during the devolatilization process.

TABLE II

| | | | | | | F | | | | | | | M | N |
|---|---|---|---|---|---|---|---|---|---|---|---|---|---|---|
| | | | | | E | 1.5% | G | H | I | | | L | 3.0% | 2.5% |
| | | B | C | D | 1.5% | H25 | 1.5% | 1.5% | 3.0% | J | K | 3.0% | MO+ | H100+ |
| | A | 1.5% | 2.5% | 3% | Low | Low | Med | High | Low | 2.5% | 2.5% | MO+ | 500 | 500 |
| Property | Control | MO | MO | MO | PIB | Med | PIB | PIB | PIB | H25 | H100 | ZnSt2 | NDM | NDM |
| Tg In ° C. | 108 | 100.2 | 100.9 | n.d. | 100.9 | 103.0 | 104.8 | n.d | n.d. | 102.4 | 105.0 | n.d. | n.d. | 101.3 |
| Melt Flow | 0.86 | 1.35 | n.d. | 1.66 | 1.2 | n.d. | 1.06 | 0.99 | 1.41 | n.d. | n.d. | 1.83 | 4.01 | n.d. |
| % Rubber | 8.5 | 7.8 | 8.3 | 8.5 | 8.1 | 8.8 | 8.6 | 7.2 | 8.8 | 9.3 | 8.8 | 7.7 | 7.8 | 9.4 |
| Swell Index | 7.11 | 9.31 | 7.28 | 9.31 | 8.86 | 7.76 | 8.36 | 10.1 | 8.53 | 7.3 | 8.18 | 7.85 | 8.57 | 9.2 |
| Gels | 22.4 | 19.4 | 19.8 | 20.0 | 19.6 | 19.8 | 20.7 | 18.6 | 20.5 | 19.7 | 19.2 | 20.6 | 18.8 | 17.1 |
| Grafting | 163 | 150 | 137 | 137 | 142 | 125 | 141 | 158 | 134 | 113 | 118 | 166 | 132 | 75 |
| Toluene | | | | | | | | | | | | | | |
| M-RPS, μ | 5.54 | 6.37 | 6.38 | 6.22 | 6.02 | 6.64 | 5.88 | 6.42 | 6.12 | 6.23 | 6.62 | 5.82 | 5.91 | 6.79 |
| Mw | 276100 | 278200 | 278700 | 282500 | 275750 | 275000 | 270800 | 278300 | 274000 | 281550 | 297500 | 272000 | 233000 | 232670 |
| Mn | 105500 | 117650 | 112600 | 114000 | 114700 | 107500 | 104300 | 114300 | 112000 | 115160 | 120400 | 112600 | 80500 | 80100 |
| MWD | 2.6 | 2.4 | 2.5 | 2.5 | 2.4 | 2.6 | 2.6 | 2.4 | 2.4 | 2.4 | 2.32 | 2.4 | 2.9 | 2.9 |
| ESCR | 39 | 61 | 62 | 76 | 56 | 69 | 86 | 75 | 55 | 85 | 91 | 84 | 40 | 95 |

NOTES:
1) n.d. - not determined
2) Viscosities - Mineral oil, 78.7 est @ 38° C./Low PIB, 27-33 cst @ 38° C./H25, 48-56 cst @ 99° C./H100, 196-233 cst @ 99° C./High PIB, 4069-4380 cst @ 99° C.
3) NDM - n-dodecyl mercaptan
4) ZnSt₂ - zinc stearate
5) The concentrations of these additives in the final product will be higher than the amounts added due the loss of a considerable portion of styrene (20-35%) during the devolatilization process.

In another embodiment of the invention, it was found that ESCR values could be improved up to a certain point solely by adding PIB to the HIPS material, as long as the molecular weight of the PIB being added is controlled within a specific range. Although ESCR values of PIB-only HIPS materials are not as good as those of MO/PIB HIPS materials, they are better than the ESCR values of HIPS without mineral oil or PIB. In low-stress HIPS applications, such PIB-only HIPS materials would provide acceptably good ESCR values, an improvement over conventional mps materials.

For example, in Table II, Samples “E”-“K” represent HIPS materials containing different molecular weight PIBs and different levels of PIBs. More specifically, Samples “E”-“H” represent samples of HIPS all having the same percent by weight of PIB but having PIBs of increasing molecular weight (as measured by viscosity). Sample “E” uses a low molecular weight pm with indicated viscosity of 27-33 cst and results in a HIPS material with ESCR value of 56. Sample “F” uses a low/medium weight PIB with viscosity of 48-56 cst to obtain an ESCR value of 69.

Sample “G” uses a medium molecular weight pm (viscosity=196-233 cst) in a HIPS material with the result that ESCR is 86. Sample “H” utilizes a high molecular weight PIB (viscosity=4069-4350 cst) and results in a drop-off in ESCR to 75.

Thus, the optimum level of PIB viscosity (molecular weight) for ESCR improvement appears to be between about 196 and 4069.

The same results are apparent in Samples “I”-“K” wherein higher levels of PIB are added to the HIPS materials and the viscosities of the PIB are varied from one sample to the other. The highest ESCR value, 91, is obtained in Sample “K” which utilizes the medium viscosity PIB (196-233 cst @ 99° C.).

Yet another embodiment of the present invention can also be discerned from Samples “L”-“N” of Table II wherein various additives have been tried in the HIPS formulations. Sample “L” utilizes a relatively high level of mineral oil (MO) and a zinc stearate, with a resulting ESCR value of 84, which while not outstanding, is marginally acceptable.

Sample “M” utilizes a combination of mineral oil and n-dodecyl mercaptan (NDM), which serves as a chain transfer agent (CTA). The ESCR value of 40 is unacceptable in HIPS material and primarily results from the presence of the CTA. On the other hand, in Sample “N” a formulation comprising medium viscosity PIB and NDM resulted in a HIPS material having an outstanding ESCR value of 95. (The NDM was added in amounts of 500 PPM of the feed solution.) Although chain transfer agents such as the mercaptan above, as well as t-dodecylmercaptan and alphamethyl styrene dimer, do not improve ESCR, but normally tend to degrade ESCR as shown by Sample “M”, they do allow the manufacturer to control certain critical properties of the HIPS material, such as polystyrene molecular weight, rubber particle size and melt flow index (i.e. ease of processing characteristics). The use of PIB additives in conjunction with CTAs, therefore, is an enabling type of system where the use of PIB allows the maker of HIPS to control the above-mentioned characteristics with CTAs, while still maintaining high ESCR values.

When referring to the “gel” level or “gel” content of the HIPS material, it is intended that this term represent the disperse phase contained in the continuous polymerized monovinylaromatic compound phase. The disperse phase, or gel, consists essentially of particles of graft copolymers of the polybutadiene rubber and polymerized monovinylaromatic compound, plus mechanically occluded particles of the polymerized monovinylaromatic compound located in the rubber particles. Gel level may be measured as the toluene-insoluble component of the rubber modified high impact compound. Gel levels are indicated in weight percents.

When referring to monovinylaromatic monomer or compound, it is intended that this include styrenes, alphamethyl styrene, and ring-substituted styrenes. When referring to rubber, it is intended that such phrase refer to natural rubber, polybutadiene, polyisoprene and copolymers of butadiene and/or isoprene with styrene. Mooney viscosity is determined using the procedures set forth at pages 109. and 110 of RUBBER TECHNOLOGY, Third Edition, a publication sponsored by the Rubber Division of the American Chemical Society, and published by Van Nostrand Reinhold Company of New York.

ESCR values are determined according to the procedures set forth in the above, incorporated patent, U.S. Pat. No. 4,777,210 at columns 10 and 11 thereof.

Synthetic Hydrocarbons

In another embodiment of the present invention ESCR properties can be improved with the addition of synthetic hydrocarbons. Synthetic hydrocarbons as used herein comprise polymerized alpha-olefins of carbon length longer than ten carbons. The synthetic hydrocarbons used herein can have viscosities from about 200 to about 1000 cst at 99° C. and a density of from about 0.80 to about 0.95 g/cc at 25° C. One example of a suitable synthetic hydrocarbon that can be used is a commercial product marketed by Petrolite Corporation under the name VYBAR 825.

The amount of synthetic hydrocarbons that can be used can range from about 0.1% to about 6% by weight. In some embodiments the synthetic hydrocarbons can be added alone or with other additives, such as with mineral oil. Embodiments can also comprise a chain transfer agent (CTA), for example, n-dodecyl mercaptan in amounts of from 1 to 500 ppm of feed solution. CTAs can be used to control certain properties of the resulting material, such as molecular weight, rubber particle size and melt flow index (i.e. ease of processing characteristics).

Experimental ESCR data obtained from tests using VYBAR 825 are provided below in Table 3.

TABLE 3
Properties of HIPS Materials containing VYBAR 825

| | | | | | | 4% |
|---|---|---|---|---|---|---|
| | | 2% Mineral | | 4% | 2% VYBAR + | Mineral |
| Property | Control | Oil | 2% VYBAR | VYBAR | 2% MO | Oil |
| Tg in ° C. | 107.96 | | 104.2 | 102.4 | | |
| Melt Flow | 1.7 | 1.15 | 1.37 | 1.5 | | |
| % Rubber | 8.48 | 8.16 | 8.19 | 8.34 | 8.73 | 7.73 |
| Swell Index | 7.63 | 7.68 | 6.28 | 6.87 | 7.46 | 9.9 |
| M-RPS, μ | 6.17 | 5.82 | 5.86 | 5.36 | 5.74 | 6.16 |
| ESCR | 41.1 | 57.8 | 48 | 92 | 88 | 71 |
| Control Tensile | 3923 | 2742 | 2864 | 2803 | 2299 | 2346 |
| Strength at Max. | | | | | | |
| (psi) | | | | | | |
| ESCR Tensile | 1614 | 1585 | 1376 | 2580 | 2027 | 1658 |
| Strength at Max. | | | | | | |
| (psi) | | | | | | |
| ESCR | 59 | 58 | 48 | 92 | 88 | 71 |

The data from Table 3 shows that the synthetic hydrocarbon used by itself up to 4% of the feed weight, resulted in increased ESCR values. When the synthetic hydrocarbon is used at lower levels in combination with mineral oil, such as for example, at 2% by weight of feed composition each, the synthetic hydrocarbon also enhances ESCR.

A base material with about 35% polystyrene in styrene was made under lab CSTR (Continuous Stirred Tank Reactor) conditions. Batches of the material was mixed with desired weights of the additive and the polymerization reaction was continued at 150° C. for one hour under batch conditions. The resulting material was devolatilized in a vacuum oven at temperatures sufficiently high enough to remove styrene and other volatiles.

The average molecular weight of the synthetic hydrocarbons that can be used within the present invention can range from about 1000 to about 3000, and have a molecular weight distribution (Mw/Mn) ranging from about 1 to about 12. The density of the synthetic hydrocarbon can range from about 0.80 g/cc to about 0.95 g/cc as measured by ASTM D 1168 at 25° C. The viscosity of the synthetic hydrocarbon can range from about 100 cP to about 500 cP at 99° C. as measured by ASTM D 3236.

Copolymers

In another embodiment of the present invention, ESCR properties can be improved with the addition of polyolefin copolymers. Non-limiting examples of applicable copolymers can comprise ethylene and propylene, and ethylene and butene. Ethylene can comprise from 0.1 to 99.9 wt % of the copolymer, can be in the range from 25 to 75 wt %, and may range from 40 to 60 wt %.

The experimental results show that in general the relative ability of a copolymer to enhance ESCR properties can vary depending on the crystallinity of the copolymer. The molar heat of fusion (ΔH_{fusion}) values (J/g) can be indicative of the crystallinity of the copolymer. It was found that typically the lower the crystallinity of the copolymer, the greater the ESCR enhancement. The samples of copolymer having a molar heat of fusion of greater than about 190 J/g resulted in ESCR values of less than 50, while those with less than about 190 J/g molar heat of fusion typically resulted in ESCR values of at least 75. FIG. 1 is a graphical illustration of the data from Table 4 that relates to molar heat of fusion (ΔH_{fusion}) values (J/g) and the resulting ESCR values obtained.

The amount of copolymer that can be used can range from about 0.1% to about 6% by weight. In some embodiments the copolymer can be added alone or with other additives, such as with mineral oil. Embodiments can also comprise a chain transfer agent (CTA), for example, n-dodecyl mercaptan in amounts of from 1 to 500 ppm of feed solution. CTAs can be used to control certain properties of the resulting material, such as molecular weight, rubber particle size and melt flow index (i.e. ease of processing characteristics).

The following table provides experimental data obtained utilizing crystalline and non-crystalline copolymers as additives. In some of the samples, additive mixtures comprising mineral oil were also tested. It can be seen that samples comprising 4% of a totally amorphous ethylene/propylene copolymer (ΔH_{fusion}=0) resulting in an ESCR value of 94. When this additive is used in a 2% mixture with mineral oil, the resulting ESCR value is 85.

TABLE 4
Comparison of ESCR Values with Crystalline and Non-crystalline Copolymers

| | | | | | | ΔHm in J/g |
|---|---|---|---|---|---|---|
| ADDITIVES | RSP, μ | % RUBBER | S.I | % GELS | ESCR | (ADDITIVE) |
| 2% Ethylene/butene Wax + 2% MO | 5.95 | 8.64 | 9.52 | 19.5 | 66 | |
| 4% Ethylene/butene Wax | 5.79 | 8.84 | 10.2 | 19.0 | 76 | |
| 2% Ethylene/butene Wax + 2% MO | 6.71 | 7.6 | 10.5 | 17 | 68 | |
| 4% Ethylene/butene Wax | 6.2 | 7.94 | 8.2 | 19.3 | 59 | 90 |
| 2% Ethylene/propylene copolymer | 6.54 | 7.60 | 9.53 | 17.8 | 85 | |
| (CP #1) + 2% MO | | | | | | |
| 4% Ethylene/propylene copolymer | 6.44 | 7.31 | 9.00 | 17.7 | 94 | 0 |
| (CP #1) | | | | | | |
| 2% (CP #2) + 2% MO | 6.97 | 7.58 | 8.75 | 18.2 | 76 | |
| 4% (CP #2) | 6.97 | 7.4 | 7.6 | 18.6 | 88 | 13.7 |
| 4% (CP #3) | 5.87 | 7.4 | 9.76 | 17.9 | 53 | 220.3 |
| 4% (CP #4) | 5.34 | 7.6 | 10.1 | 18.4 | 50 | 190.6 |
| 4% (CP #5) | 6.07 | 8.0 | 9.58 | 18.4 | 80 | 178.3 |
| 2% (CP #6) | 5.99 | 8.16 | 8.23 | 21.2 | 48 | 125.95 |
| 2% (CP #6) + 2% MO | 6.41 | 7.87 | 8.31 | 21.2 | 64 | |
| 2% (CP #7) | 5.1 | 7.77 | 7.46 | 21.7 | 42 | 229.4 |
| 2% (CP #7) + 2% MO | 5.3 | 8.19 | 8.70 | 20.2 | 60 | |
| 2% (CP #8) | 5.9 | 7.92 | 7.63 | 21.6 | 37 | 238.7 |
| 2% (CP #8)2% MO | 6.5 | 8.0 | 8.55 | 20.9 | 37 | |
| (CP #9) (Contains ˜4% crystalline PE + 3% | 8.17 | 7.78 | 11.0 | 24.9 | 81 | |
| MO | | | | | | |

Atactic PP

In another embodiment of the present invention, ESCR properties can be improved with the addition of atactic polypropylenes (aPP). It is understood that aPP may contain some ethylene within its structure along with other items, such as for example, aluminum compounds or other residual catalyst, co-catalyst and/or donor materials. If polymers such as ethylene or butene are present in significant quantities, the composition can then be referred to as a polyolefin copolymer, as discussed above.

The amount of atactic polypropylenes that can be used can range from about 0.1% to about 6% by weight. In some embodiments the atactic polypropylenes can be added alone or with other additives, such as with mineral oil. Embodiments can also comprise a chain transfer agent (CTA), for example, n-dodecyl mercaptan in amounts of from 1 to 500 ppm of feed solution. CTAs can be used to control certain properties of the resulting material, such as molecular weight, rubber particle size and melt flow index (i.e. ease of processing characteristics).

Table 5 provides experimental data obtained utilizing atactic polypropylene as an additive. In some of the samples, additive mixtures comprising mineral oil were also tested. It can be seen that samples comprising 4% of a particular atactic polypropylene resulting in ESCR value of 92. When this additive was used in a mixture with mineral oil, each at 2%, the resulting ESCR value is 81.

TABLE 5
ESCR of HIPS containing Atactic Polypropylenes with Different Characteristics

| | | | | | | | | ESCR (% |
|---|---|---|---|---|---|---|---|---|
| | Mn | Mw | MWD | RPS, | % | | % | Tensile |
| ADDITIVES | (aPP) | (aPP) | (aPP) | μ | RUBBER | S.I. | GELS | Strength Rtd.) |
| Control (No MO | | | | 6.14 | 7.72 | 7.1 | 19.1 | 40 |
| or No Additive | | | | | | | | |
| 2% aPP-1 | 700 | 1000 | 1.4 | 5.53 | 7.36 | 8.42 | 18.8 | 48 |
| 2% aPP-1 + 2% | | | | 6.86 | 7.33 | 13.4 | 14.9 | 66 |
| Mineral Oil | | | | | | | | |
| 4% aPP-1 | | | | 5.67 | 7.66 | 9.49 | 18.0 | 68 |
| 2% aPP-2 | 1630 | 3170 | 1.9 | 5.57 | 8.05 | 8.34 | 19.4 | 63 |
| 4% aPP-2 | | | | 6.11 | 8.48 | 7.66 | 19.8 | 92 |
| 2% aPP-2 + 2% | | | | 6.01 | 7.77 | 9.6 | 18.1 | 81 |
| Mineral Oil | | | | | | | | |
| 2% aPP-3 + 2% | 3005 | 23550 | 7.9 | 6.95 | 7.9 | 9.3 | 18.5 | 74 |
| Mineral Oil | | | | | | | | |
| 4% aPP-3 | | | | 6.74 | 8.9 | 9.4 | 18.6 | 87 |
| 2% aPP-4 + 2% | 1760 | 8885 | 5.1 | 6.10 | 8.3 | 8.45 | 18.5 | 87 |
| Mineral Oil | | | | | | | | |
| 4% aPP-4 | | | | 6.40 | 7.55 | 9.2 | 17.8 | 86 |

Having described specific embodiments of the present invention, it will be understood that modifications thereof may be suggested to those skilled in the art, and it is intended to cover all such modifications as fall within the scope of the appended claims.

What is claimed:

1. A composition comprising:
a rubber-modified polymer formed by the polymerization of a monovinylaromatic monomer in the presence of a rubber selected from the group consisting of natural rubbers, polybutadienes, polyisoprenes, and copolymers of butadienes or isoprene with styrene; and
at least one ESCR enhancing additive chosen from the group consisting of polyisobutylene, polymerized alpha-olefins of at least 10 carbons, atactic polypropylene, or polyolefin copolymers.

2. The composition of claim 1 wherein the ESCR enhancing additive is added to the polymer composition in amounts of from about 0.1 wt % to about 6 wt % of the composition.

3. The composition of claim 1 further comprising mineral oil in amounts of from about 0.1 wt % to about 6 wt % of the composition.

4. The composition of claim 1 wherein the resulting composition has an ESCR value greater than about 75.

5. The composition of claim 1 wherein the rubber is in the range of about 5 to 15 percent by weight.

6. The composition of claim 1 wherein more than one ESCR enhancing additive is present in the amount of about 0.5 to about 3.0 percent by weight each.

7. The composition of claim 1 wherein the ESCR enhancing additive comprises a liquid synthetic hydrocarbon.

8. The composition of claim 1 wherein the ESCR enhancing additive comprises polymerized alpha-olefins of at least 10 carbons having a viscosity range of about 200-1000 cst @99° C.

9. The composition of claim 1 wherein the ESCR enhancing additive comprises polymerized alpha-olefins of at least 10 carbons having a density range of about 0.80-0.95 g/cc @25° C.

10. The composition of claim 1 wherein the ESCR enhancing additive comprises VYBAR 825.

11. The composition of claim 1 wherein the monovinylaromatic monomer is selected from the group consisting of styrene, alphamethyl styrene and ring-substituted styrenes.

12. The composition of claim 1 wherein the monovinylaromatic monomer comprises styrene and the additives are added to the compound prior to or during polymerization.

13. The composition of claim 1 wherein the ESCR enhancing additive comprises atactic polypropylene and the final composition has an ESCR of at least 75.

14. The composition of claim 1 wherein the ESCR enhancing additive comprises copolymers of ethylene and propylene that are amorphous ethylene-propylene copolymers.

15. The composition of claim 14 wherein the molar heat of fusion for the copolymer is less than about 190 J/g.

16. The composition of claim 1 further comprising a chain transfer agent.

17. Molded thermoplastic article made from the polymeric composition of claim 1.

18. The article of claim 17, wherein the article comprises a refrigerator liner.

19. The article of claim 17, wherein the article comprises a molded thermoplastic food product container.

20. A process for producing a composition, comprising:
polymerizing a mixture of a monovinylaromatic monomer and rubber, the monovinylaromatic monomer being selected from the group consisting of styrene, alphamethyl styrene and ring-substituted styrenes, and the rubber being selected from the group consisting of polybutadiene, polyisoprene, copolymers of butadiene or isoprene with styrene, and natural rubbers; and
adding to the mixture of monomer and rubber, prior to or during the polymerizing process, at least one ESCR enhancing additive chosen from the group consisting of polyisobutylene, polymerized alpha-olefins of at least 10 carbons, atactic polypropylene, or a polyolefin copolymer.

21. The process of claim 20 further comprising adding mineral oil to the mixture in amounts of from about 0.1 wt % to about 6 wt % of the composition.

22. The process of claim 20 wherein the ESCR enhancing additive is added to the mixture in amounts of from about 0.1 wt % to about 6 wt % of the composition.

23. The process of claim 20 wherein the resulting composition has an ESCR value greater than about 75.

24. The process of claim 20 wherein the rubber is in the range of about 5 to 15 percent by weight.

25. The process of claim 20 further comprising adding a chain transfer agent to the mixture.

26. A food service article made from a composition comprising:
a rubber-modified polymer formed by the polymerization of a monovinylaromatic monomer in the presence of a rubber; and
at least one ESCR enhancing additive chosen from the group consisting of polyisobutylene, polymerized alpha-olefins of at least 10 carbons, atactic polypropylene, or a polyolefin copolymer.

27. The food service article of claim 26, wherein the composition has an ESCR value of at least 75.

28. The food service article of claim 26, wherein the article comprises a refrigerator liner.

29. The food service article of claim 26, wherein the article comprises a molded thermoplastic food product container.
